(19) United States
(12) Patent Application Publication
(10) Pub. No.: US 2014/0204495 A1
(43) Pub. Date: Jul. 24, 2014

(54) RELEASE UNIT FOR TRIPPING A TRIPPING ELEMENT OF AN ELECTRICAL SWITCHING DEVICE AND ELECTRICAL SWITCHING DEVICE

(71) Applicant: SIEMENS AKTIENGESELLSCHAFT, München (DE)

(72) Inventor: Jürgen Renner, Amberg (DE)

(73) Assignee: SIEMENS AKTIENGESELLSCHAFT, Munchen (DE)

(21) Appl. No.: 14/239,799

(22) PCT Filed: Oct. 15, 2012
(86) PCT No.: PCT/EP2012/070392

§ 371 Date: Feb. 20, 2014

(30) Foreign Application Priority Data
Nov. 2, 2011 (DE) 10 2011 085 601.3

(51) Int. Cl. H01H 71/10

(52) U.S. Cl. CPC H01H 71/10
USPC 361/115

(57) ABSTRACT

An embodiment of the invention relates to a release unit for tripping an electrical switching device, having two or more releases, at least one interface for receiving electrical input signals for each of the releases, a common interface to a tripping element, which is designed to mechanically trip the electrical switching device, wherein the common interface is designed for transmitting a common electrical output signal to the tripping element, wherein each release includes electronics for converting the respective electrical input signal into the common electrical output signal. In addition, an embodiment of the invention relates to electrical switching devices having such a release unit.

### PRIORITY STATEMENT

This application is the national phase under 35 U.S.C. §371 of PCT International Application No. PCT/EP2012/070392 which has an International filing date of Oct. 15, 2012, which designated the United States of America, and which claims priority to German patent application number DE 102011085601.3 filed Nov. 11, 2011, the entire contents of each of which are hereby incorporated herein by reference.

### FIELD

At least one embodiment of the invention generally relates to a tripping element of an electrical switching device.

### BACKGROUND

Electrical switching devices, such as circuit breakers, have the task of decoupling a number of consumers from a voltage supply grid when a certain fault occurs. The classic fault is the occurrence of a short-circuit current, and the circuit breakers are conventionally designed to move a switching element and thus to decouple the connection between consumers and the voltage supply grid in the event of such a short-circuit current.

In addition, such decoupling of consumers and the voltage supply grid is also desirable in other situations, however. In particular, it may be that the voltage supply grid is isolated from the consumers in the event of an undervoltage in the voltage supply grid. In order to provide functionality for this, further releases, so-called auxiliary releases, are used. Auxiliary releases can monitor both the main circuit, i.e. the voltage supply grid, and auxiliary circuits. That is to say that circuit breakers, in particular compact circuit breakers, can be disconnected with the aid of auxiliary releases. These are preferably electromagnetic releases, which usually have an energy store and which trip either when a voltage is applied, in which case they are so-called open-circuit shunt releases, or when a limit voltage is undershot, in which case they are so-called undervoltage releases. In the case of open-circuit shunt releases, there are also directly active electromagnetic releases which operate without an additional energy store.

Such auxiliary releases are typically in the form of a module which can be fastened on a pocket, for example, a withdrawable compartment, of the circuit breaker. Part of the tripping mechanism in a circuit breaker is conventionally a switching mechanism. Auxiliary releases can have an effect on precisely this switching mechanism or on a switching element of the switching mechanism and thus effect decoupling of the consumer from the voltage supply grid by the circuit breaker. For this, they are equipped with a tripping element, for example a plunger. The tripping element, namely in particular the plunger, is in a withdrawn state when untripped. For tripping, the tripping element moves out of a housing of the auxiliary release.

That is to say that, in the case of electrical switching devices such as circuit breakers, in particular compact circuit breakers, there is in addition to the basic tripping types “overload” or “short circuit” in the main circuit, accessory components, in particular releases, which are likewise intended to trip the circuit breaker in the event of incoming electrical signals. In this case, there are releases which are found as standard in the circuit breaker and releases which can be built into or removed from the circuit breaker, optionally. Until now, each of these releases has a separate interface to a tripping mechanism, for example a tripping shaft, of the circuit breaker. That is to say that each release receives an electrical signal in the event of a fault, for example in the event of a short circuit, and converts this electrical signal into a mechanical signal, which moves the tripping mechanism, such as the tripping shaft, and thus switches or “unlatches” the circuit breaker. That is to say that each individual release converts an incoming electrical signal into a mechanical signal.

Thus, an electronic overcurrent release (ETU release) can trip the circuit breaker in the event of a short circuit or in the event of an overload in a main circuit. Such a release is generally provided as standard in a circuit breaker. A residual current circuit breaker (RCD release) which can optionally be provided in a circuit breaker can trip the circuit breaker in the event of a residual current in the main circuit. In addition, an undervoltage release (UVR) which can trip the circuit breaker in the event of the presence of an undervoltage in an auxiliary circuit or an open-circuit shunt release (SHT release) which can trip the circuit breaker in the event of the presence of a working current in the auxiliary circuit can be provided in a circuit breaker.

The design of the mechanical interfaces between a release and a circuit breaker is usually complex. Thus, each release has at least two interfaces, namely a tripping interface and a charging interface. In order to be able to realize these two interfaces uniformly over different circuit breaker sizes, a considerable amount of design complexity is often required.

That is to say that if two or more releases are provided in an electrical switching device, such as a circuit breaker, a charging interface and a tripping interface need to be provided for each release. This is complex in design terms, requires increased amounts of space and is cost-intensive.

In addition, each release generally has a separate energy store. Each energy store in turn has a certain space requirement, with the result that a once again increased space requirement is necessary in the circuit breaker. If a plurality of releases are built into the circuit breaker, the circuit breaker is “overcrowded”. That is to say that, by virtue of the provision of a plurality of circuit breakers, there is little space remaining in the circuit breaker for other internal system components.

### SUMMARY

At least one embodiment of the invention resides in realizing tripping of an electrical switching device, such as a circuit breaker, and thus an electrical switching device such as a circuit breaker in a manner which is as simple, space-saving and inexpensive as possible.

At least one embodiment of the invention is directed to a release unit for tripping an electrical switching device, an electrical switching device and/or an electrical switching device. In this case, features and details which are described in connection with the release unit according to embodiments of the invention of course also apply in connection with the electrical switching devices according to the invention, and vice versa, with the result that reference is always and can always be made mutually with respect to the disclosure of the individual aspects of embodiments of the invention.

In accordance with the first aspect of an embodiment of the invention, a release unit for tripping an electrical switching device is disclosed, having two or more releases, at least one interface for receiving electrical input signals for each of the releases, a common interface for a tripping element, which is designed to mechanically trip the electrical switching device, wherein the common interface is designed for transmitting a uniform electrical output signal to the tripping element, wherein each release has electronics for converting the respective electrical input signal into the uniform electrical output signal.

A second embodiment of the invention is directed to an electrical switching device having a release unit having a tripping element in accordance with the first aspect of an embodiment of the invention and a tripping mechanism for tripping the electrical switching device, wherein the tripping mechanism has a connection interface to the tripping interface of the tripping element for transmitting the mechanical signal from the tripping element to the tripping mechanism of the electrical switching device, and wherein the tripping mechanism is designed to disconnect the electrical switching device on reception of the mechanical signal.

In a third embodiment of the invention, an electrical switching device includes a release unit, a tripping element for converting the output signal generated by the release unit into a mechanical signal, wherein the tripping element has a first interface for connection to the common interface of the release unit, a tripping interface to a tripping mechanism of the electrical switching device for transmitting the mechanical signal to the tripping mechanism, wherein the mechanical signal is suitable for tripping the tripping mechanism, and a charging interface for transmitting energy to the tripping element, and having a tripping mechanism for tripping the electrical switching device, wherein the tripping mechanism has a connection interface to the tripping interface of the tripping element for transmitting the mechanical signal from the tripping element to the tripping mechanism of the electrical switching device, and wherein the tripping mechanism is designed to disconnect the electrical switching device on reception of the mechanical signal.

### BRIEF DESCRIPTION OF THE DRAWINGS

Example embodiments of the invention will be explained in more detail below with reference to the attached figures, in which:

FIG. 1 shows a schematic illustration of a release unit which is designed in accordance with the design principle according to an embodiment of the invention,

FIG. 2 shows a schematic illustration of a release unit comprising a tripping element which is designed in accordance with the design principle according to an embodiment of the invention,

FIG. 3 shows a schematic illustration of the release unit shown in FIG. 2 connected to an electrical switching device, and

FIG. 4 shows a schematic illustration of a release unit shown in FIG. 1 connected to an electrical switching device.

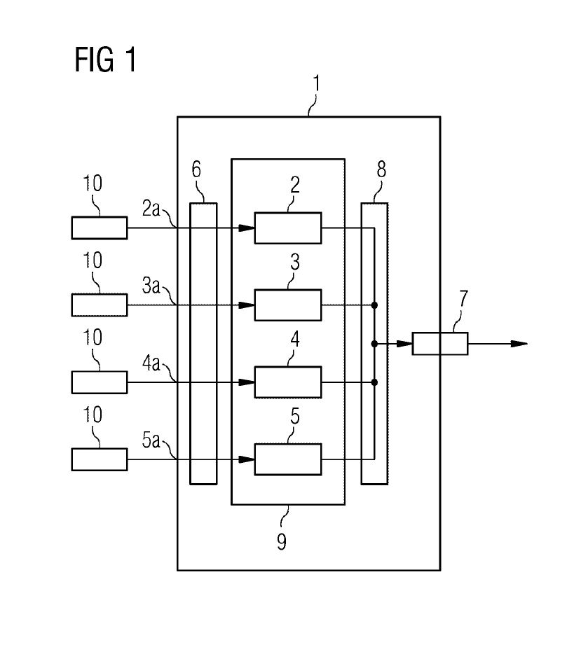

Elements having an identical function and mode of operation have each been provided with the same reference signs in FIGS. 1 to 4.

### DETAILED DESCRIPTION OF THE EXAMPLE EMBODIMENTS

At least one embodiment of the invention is directed to a release unit for tripping an electrical switching device, an electrical switching device and/or an electrical switching device. In this case, features and details which are described in connection with the release unit according to embodiments of the invention of course also apply in connection with the electrical switching devices according to the invention, and vice versa, with the result that reference is always and can always be made mutually with respect to the disclosure of the individual aspects of embodiments of the invention.

In accordance with the first aspect of an embodiment of the invention, a release unit for tripping an electrical switching device is disclosed, having two or more releases, at least one interface for receiving electrical input signals for each of the releases, a common interface for a tripping element, which is designed to mechanically trip the electrical switching device, wherein the common interface is designed for transmitting a uniform electrical output signal to the tripping element, wherein each release has electronics for converting the respective electrical input signal into the uniform electrical output signal.

A release unit with such a design enables simple, space-saving and inexpensive tripping, i.e. switching, of an electrical switching device in the event of a fault in a voltage supply grid to a consumer. Since two or more releases are provided in the release unit, wherein the releases have different designs, the release unit can be used in the case of different faults in a voltage supply grid to a consumer.

The release unit, i.e. all of the releases provided, is designed for connection to a common tripping element. Only the connection technology to a voltage supply grid via the interfaces for reception of electrical input signals from the voltage supply grid and the conversion of the incoming electrical input signals continue to be left to the individual releases. Each release has corresponding electronics for converting electrical input signals into a common output signal.

The release unit according to an embodiment of the invention enables a reduction in interfaces to a tripping element of an electrical switching device, in particular a circuit breaker, such as a compact circuit breaker. Such a release unit has a compact design. Since the release unit can generate a uniform output signal independently of the nature of the incoming input signal, the tripping element connected downstream of the release unit can have a simple, in particular standardized, design. That is to say that, by virtue of the release unit according to an embodiment of the invention, technical difficulties in the case of a downstream tripping element which is in particular arranged in an electrical switching device, such as a circuit breaker, can be reduced. As a result, the quality of an electrical switching device can be increased.

The connection possibility of a standardized tripping element to the release unit reduces the development complexity of the tripping element. Only space for the connection technology and the electronics is required in the release unit. By virtue of such a release unit, an electrical switching device can have a more simple, more space-saving and less expensive design. Owing to the use of such a release unit in an electrical switching device, such as a circuit breaker, the tripping element arranged between the release unit and the tripping mechanism of the electrical switching device, which tripping element can convert an electrical signal into a mechanical signal, can have a simple and inexpensive design. In particular, in the case of such a tripping element, only a single energy store can be provided since, by virtue of the release unit, a uniform output signal is sent to the tripping element after the occurrence of a fault in a supply grid.

In accordance with a preferred development of an embodiment, provision can be made in a release unit for each release to be designed for converting an electrical input signal formed as an electrical voltage into a uniform electrical output signal formed as a signal current. Owing to the signal current, the tripping element can be tripped. Since the signal current, independently of the release of the release unit, always has an identical value, it is ensured that different faults can be processed in a voltage supply grid to a consumer with one and the same tripping element. The energy store of the tripping element can always be designed identically since the signal current for tripping the energy store and therefore for converting the output signal sent by the release unit to the tripping element into a mechanical signal is always the same.

The common interface of a release unit according to an embodiment of the invention can have different designs. The common interface is designed for transmitting the output signal generated by the release unit to a downstream tripping element. Particularly preferred is a release unit in which the common interface is in the form of a plug-type connection. As a result, the release unit can be connected easily and quickly to a tripping element and thus to an electrical switching device. The flexibility of the release unit is increased by a common interface in the form of a plug-type connection. Within the meaning of the invention, common interface means that only a single interface is required for transmitting the output signal generated by the different releases of the release unit.

In accordance with a further preferred development of an embodiment of the invention, in a release unit provision may be made for a first release to be designed to convert a short-circuit current signal and/or an overload voltage signal into the uniform output signal, for a second release to be designed to convert a residual current signal into the uniform output signal, for a third release to be designed to convert an undervoltage signal into the uniform output signal and/or for a fourth release to be designed to convert a working current signal into the uniform output signal. Thus, at least two such releases can be provided in a release unit. A release unit with such a design can initiate tripping of an electrical switching device in the event of the occurrence of different faults, such as the occurrence of an undervoltage or fault voltage.

A release unit according to an embodiment of the invention can be used for tripping a tripping element of an electrical switching device, such as a circuit breaker, in particular a compact circuit breaker. In accordance with a particularly preferred development of an embodiment of the invention, in a release unit provision can be made for the tripping element for converting the generated output signal into a mechanical signal to be part of the release unit, wherein the tripping element has a first interface for connection to the common interface, a tripping interface to a tripping mechanism of the electrical switching device for transmitting the mechanical signal to the tripping mechanism, wherein the mechanical signal is suitable for tripping the tripping mechanism, and a charging interface for transmitting energy to the tripping element. A release unit with such a design has a simple, space-saving and inexpensive design. In particular, such a release unit can be connected easily and quickly to electrical switching devices, in particular compact circuit breakers. The use of such a release unit in an electrical switching device makes it possible for the switching device itself to be capable of having a simple and inexpensive design. The release unit can be connected flexibly to different electrical switching devices since a wide variety of faults in a main and/or auxiliary circuit to a consumer can be covered by the two or more different releases of the release unit.

The tripping element is designed to convert the generated output signal into a mechanical signal. The tripping element has a first interface for connection to the common interface. As a result, a uniform output signal which has been generated by one of the releases of the release unit can be passed onto the tripping element. This output signal can be converted into a mechanical signal by the tripping element, which mechanical signal in turn is used for tripping or switching a tripping mechanism of the electrical switching device, for example a tripping shaft. For this purpose, the tripping element has a tripping interface to a tripping mechanism of the electrical switching device. The mechanical signal generated by the tripping element is suitable for tripping the tripping mechanism of an electrical switching device, such as a compact circuit breaker. In addition, the tripping element has a charging interface for transmitting energy to the tripping element. That is to say that, via the charging interface, which can also be referred to as reset interface, it is possible to transfer the tripping element to a first state. Once an output signal has been transmitted to the tripping element, the tripping element is transferred from the first state into a second state. During the transition from the first state to the second state, the electrical output signal is converted into a mechanical signal. The charging interface provides the possibility of transferring the tripping element back to the first state. In this case, energy is supplied to the tripping element. For example, an actuating mechanism such as a rotor shaft or a lever can be connected to the charging interface.

In accordance with a preferred development of an embodiment of the invention, in a release unit provision may be made for the tripping element to have an electromagnet for converting the electrical output signal into the mechanical signal. The electromagnet can convert an electrical output signal into a mechanical signal. Thus, by means of an output signal in the form of a signal current, a coil of the electromagnet can produce a magnetic field. As a result of this magnetic field, a mechanical signal can be generated, in particular an armature or a plunger of the tripping element can be moved by the magnetic field. This movement of the armature or the plunger can be transmitted to the tripping mechanism of the electrical switching device.

Particularly preferably, in such a release unit provision can be made for the tripping element to have an energy store, which is connected downstream of the electromagnet and is designed to amplify the mechanical signal generated by the electromagnet. The energy store ensures that a mechanical signal with a sufficiently high intensity is generated for switching the tripping mechanism by the tripping element. The energy store can be tripped, for example, by an armature or a plunger of the tripping element and can thus be transferred from its first state into the second state. The energy store is connected to the tripping mechanism of an electrical switching device in such a way that, when the energy store is transferred to the second state, the tripping mechanism is switched for switching the electrical switching device. The energy store can have a variety of designs. For example, the energy store can be a spring element, such as a compression or tension spring. Energy can be supplied to the energy store via the charging interface. By way of example, a spring element can be pretensioned via the charging interface. If, for example, a spring element has been pretensioned, it is in the first state. By means of the mechanical signal generated by the tripping element, the pretensioning of the spring element can be initiated. The increased force of the energy store ensures safe switching of the tripping mechanism of the electrical switching device.

A second embodiment of the invention is directed to an electrical switching device having a release unit having a tripping element in accordance with the first aspect of an embodiment of the invention and a tripping mechanism for tripping the electrical switching device, wherein the tripping mechanism has a connection interface to the tripping interface of the tripping element for transmitting the mechanical signal from the tripping element to the tripping mechanism of the electrical switching device, and wherein the tripping mechanism is designed to disconnect the electrical switching device on reception of the mechanical signal.

An electrical switching device with such a design has a simple, space-saving and inexpensive design. In particular, by virtue of the connection of such a release unit, space can be kept free for other system components of the electrical switching device. Since only one interface from the release unit, which has at least two different releases, to the tripping element is required, the entire unit comprising the release unit and the tripping element is simpler and less expensive. In particular by virtue of the fact that the electrical switching device now only requires a single tripping element in order to convert signals from different releases, the entire electrical switching device has a simpler and less expensive design than previously known electrical switching devices. Normally, the overload and short-circuit protection means, i.e. generally also the associated release, are integrated in the circuit breaker. That is to say that the actual electrical switching device can be produced in a standardized manner without releases and then completed with a corresponding release unit comprising at least two releases and a tripping element.

Since the release unit of the electrical switching device has two or more releases which are designed differently, the electrical switching device can interrupt the supply of current to the consumer and thus protect the consumer in the case of different faults in a voltage supply grid to a consumer.

By virtue of the fact that the release unit has a single tripping element for different releases, the electrical switching device can have a space-saving design or can have sufficient space for further components.

An electrical switching device, such as a compact circuit breaker, is designed in a simple manner by virtue of the fact that said electrical switching device does not need to have a dedicated tripping element since the tripping element is part of the release unit of the electrical switching device, which can be connected retrospectively as a module to the electrical switching device.

The release unit according to an embodiment of the invention provides a reduction in the mechanical interfaces in an electrical switching device, in particular a circuit breaker, such as a compact circuit breaker. In particular, only one charging interface and one tripping interface are necessary between the electrical switching device and the tripping element of the release unit. As a result, the design complexity involved in the manufacture of the electrical switching device can be kept low. At the same time, such an electrical switching device can have a relatively large amount of space for other system components.

In a third embodiment of the invention, an electrical switching device includes a release unit, a tripping element for converting the output signal generated by the release unit into a mechanical signal, wherein the tripping element has a first interface for connection to the common interface of the release unit, a tripping interface to a tripping mechanism of the electrical switching device for transmitting the mechanical signal to the tripping mechanism, wherein the mechanical signal is suitable for tripping the tripping mechanism, and a charging interface for transmitting energy to the tripping element, and having a tripping mechanism for tripping the electrical switching device, wherein the tripping mechanism has a connection interface to the tripping interface of the tripping element for transmitting the mechanical signal from the tripping element to the tripping mechanism of the electrical switching device, and wherein the tripping mechanism is designed to disconnect the electrical switching device on reception of the mechanical signal.

In the case of such an electrical switching device, the tripping element is part of the electrical switching device and not part of the release unit. This electrical switching device, such as a circuit breaker, also has a very flexible design. Different release units can be connected in modular fashion easily to the tripping element of the electrical switching device. The electrical switching device only requires a common interface to the release unit, with the result that a uniform output signal can be transmitted from the release unit to the tripping element. In order to supply energy to the tripping element and to trip a tripping mechanism of the electrical switching device, only two interfaces, namely a charging interface and a tripping interface, are required.

Such electrical switching devices can be manufactured with relatively little development complexity involved. The technical, in particular design-related difficulties can be reduced with such electrical switching devices, i.e. with electrical switching devices in accordance with the second and third embodiments of the invention, as a result of which the quality of such electrical switching devices can be increased. The complexity in terms of development and therefore the development costs of such electrical switching devices can be kept relatively low. Also only one energy store is required for the electrical switching device, in particular circuit breaker, with a single “central” tripping element. As a result, the physical space required for an electrical switching device can be reduced or the free physical space is available for other system components. The provision of a common “central” tripping element only requires space for the connection technology and the electronics of the release unit.

In accordance with a preferred development of an embodiment of the invention, in such an electrical switching device provision can be made for the tripping element to have an electromagnet for converting the electrical output signal into the mechanical signal. The electromagnet can convert an electrical output signal into a mechanical signal. Thus, a coil of the electromagnet can produce a magnetic field by way of an output signal in the form of a signal current. A mechanical signal can be generated by this magnetic field; in particular an armature or a plunger of the tripping element can be moved by the magnetic field. This movement of the armature or the plunger can be transmitted to the tripping mechanism of the electrical switching device.

Particularly preferably, in the case of such an electrical switching device provision can be made for the tripping element to have an energy store, which is connected downstream of the electromagnet and which is designed to amplify the mechanical signal generated by the electromagnet. The energy store ensures that a mechanical signal with a sufficiently high strength for switching the tripping mechanism by the tripping element is generated. The energy store can be tripped, for example, by an armature or a plunger of the tripping element and thus transferred from its first state into the second state. The energy store is connected to the tripping mechanism of an electrical switching device in such a way that, when the energy store is transferred to the second state, the tripping mechanism is switched so as to switch the electrical switching device. The energy store can have a variety of designs. For example, the energy store can be a spring element, such as a compression or tension spring. Energy can be supplied to the energy store via the charging interface. That is to say that the charging interface is designed to transmit energy to the energy store. For example, a spring element can be pretensioned via the charging interface. If, for example, a spring element is pretensioned, it is in the first state. The pretensioning of the spring element can be initiated by the mechanical signal generated by the tripping element. The increased force of the energy store ensures safe switching of the tripping mechanism of the electrical switching device.

In accordance with a further preferred development of an embodiment of the invention, in the case of an electrical switching device provision can be made for the charging interface to be designed to transmit energy to the energy store. The charging interface can also be referred to as the reset interface. Energy can be transmitted to the tripping element via the charging interface. That is to say that the charging interface serves the purpose of setting the tripping element to its charged, in particular tensioned state. For example, an actuating mechanism such as a rotor shaft or lever of the electrical switching device can be connected to the charging interface.

In the case of an electrical switching device, provision can preferably be made for the tripping mechanism of the electrical switching device to have a switching mechanism, a tripping shaft and/or a tripping latch. The tripping mechanism serves to switch or unlatch the electrical switching device. The tripping mechanism can be actuated by the mechanical signal which has been generated by the tripping element. The mechanical signal can be a shifting of a plunger, for example.

The electrical switching device can have a variety of designs. Thus, the electrical switching device can be, for example, a circuit breaker or a contactor. Particularly preferably, the electrical switching device is a circuit breaker, in particular a compact circuit breaker. In the case of circuit breakers, in particular compact circuit breakers, two or more releases are often used which protect the electrical switching device from faults in the voltage supply grid. Such circuit breakers have the task of decoupling consumers from a voltage supply grid when a certain fault occurs. The conventional fault is the occurrence of a short-circuit current, and the circuit breakers are designed to move the tripping mechanism, such as a tripping shaft, a switching mechanism or a switching element, of the circuit breaker in the event of such a short-circuit current and thus to disconnect the connection between a consumer to be protected and the voltage supply grid.

FIG. 1 shows a release unit 1 for tripping an electrical switching device, which release unit is designed in accordance with the design principle according to the invention. The release unit 1 has four different releases 2, 3, 4, 5. In addition, the release unit 1 has four interfaces 2a, 3a, 4a, 5a, which are designed to receive electrical input signals 6, in particular in the form of signal currents 10, for each of the releases 2, 3, 4, 5. Furthermore, the release unit 1 has a common interface 7, which is used for connection to a tripping element. The common interface 7 is designed to transmit a uniform electrical output signal 8 to a downstream tripping element. Each of the releases 2, 3, 4, 5 has electronics 9 for converting the respective electrical input signal 6 into the uniform electrical output signal 8.

A release unit 1 having such a design enables simple, inexpensive and space-saving tripping of an electrical switching device. In this case, the release unit 1 converts the input signals 6 which are incoming in particular as signal current 10 into a uniform output signal 8, which can be passed on to a downstream tripping element via the common interface 7 of the release unit 1. In order to convert the electronic input signals 6 into a common output signal 8, each release 2, 3, 4, 5 has corresponding electronics 9. The release unit 1 enables a reduction in the mechanical interfaces 7 to a downstream tripping element of an electrical switching device, in particular a circuit breaker, such as a compact circuit breaker. The release unit 1 can generate a uniform electrical output signal 8 independently of the nature of the incoming signal current 10 or input signal 6. As a result, the tripping element connected downstream of the release unit 1 can have a simple, in particular standardized, design.

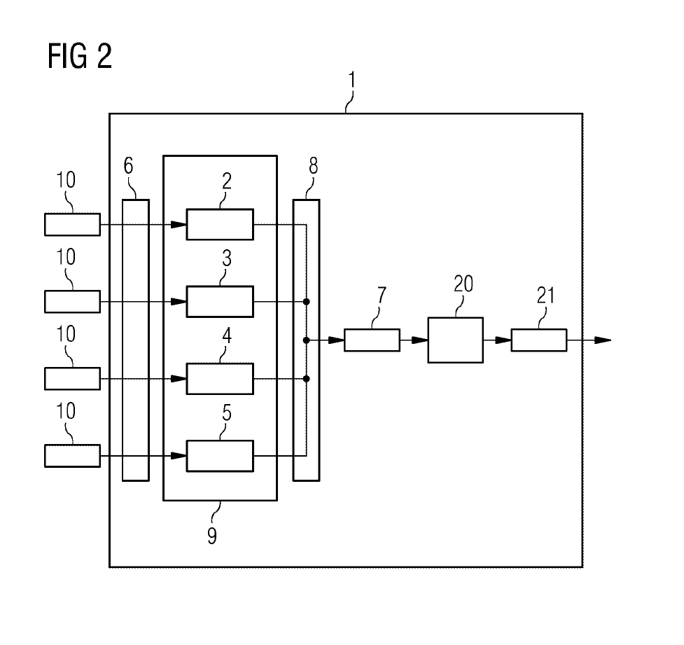

Such a tripping element 20 is illustrated in FIG. 2. The tripping element 20 in this embodiment of the release unit 1 is part of the release unit 1. It is advantageous in the case of such a release unit 1 that only a single tripping element 20 is required irrespective of the incoming signal current 10, which may be a short-circuit current, a residual current, a working current, etc., or the incoming input signal 6. This is ensured by virtue of the fact that the different signal currents 10 or input signals 6 are converted in the electronics 9 of the individual releases 2, 3, 4, 5 into a uniform electrical output signal 8. That is to say that the tripping element 20 need only be designed for a certain uniform electrical output signal 8 and can therefore be standardized. The output signal 8 is passed on to the tripping element 20 via the common interface 7. The tripping element 20 converts the incoming output signal 8 into a mechanical signal 21, for example a movement of a plunger. That is to say that the mechanical signal 21 can move the tripping mechanism of a downstream electrical switching device and therefore switch or unlatch the electrical switching device. A release unit 1 with such a design has a simple, space-saving and inexpensive design. In particular, such a release unit 1 can be connected easily and quickly to electrical switching devices, such as compact circuit breakers. That is to say that the use of such a release unit 1 in an electrical switching device makes it possible for the electrical switching device itself to be capable of having a simple and inexpensive design. Owing to the fact that the release unit 1 can convert different input signals 6 into a uniform output signal and thus into a uniform mechanical signal 21, the release unit 1 can be connected flexibly to very different electrical switching devices. A wide variety of faults in a voltage supply grid can be covered by such a release unit 1.

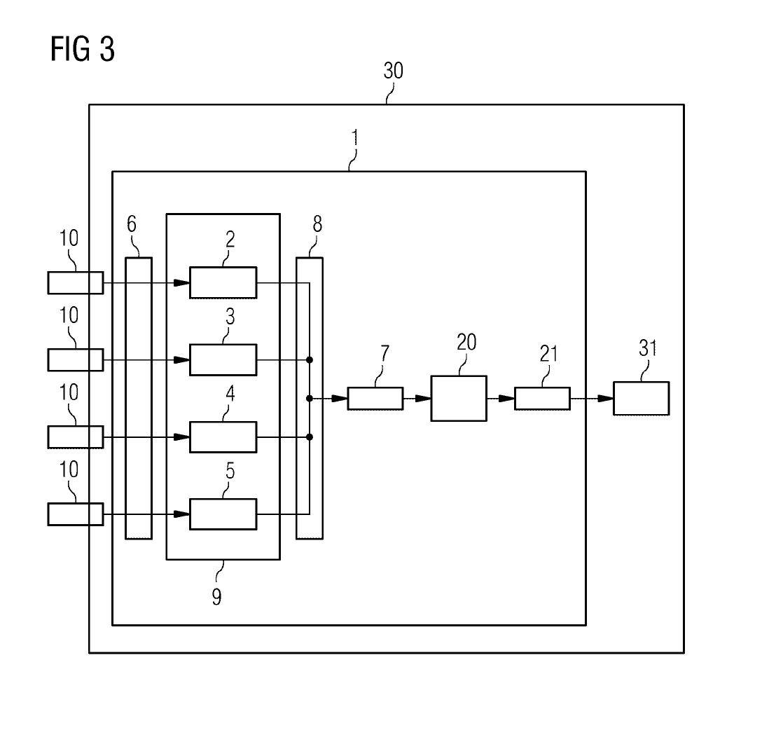

FIG. 3 shows a release unit 1 as shown in FIG. 2 which is connected to an electrical switching device 30, such as a circuit breaker, for example, in particular a compact circuit breaker. The electrical switching device 30 is connected to a tripping interface of the tripping element 20 via a connection interface. The mechanical signal 21 generated by the tripping element 20 can be transmitted to the tripping mechanism 31 of the electrical switching device 30 via these interfaces, with the result that the tripping mechanism 31 can disconnect the electrical switching device 30 after reception of the mechanical signal 21. Since the tripping element 20 is part of the release unit 1, the electrical switching device 30 can have a very simple design.

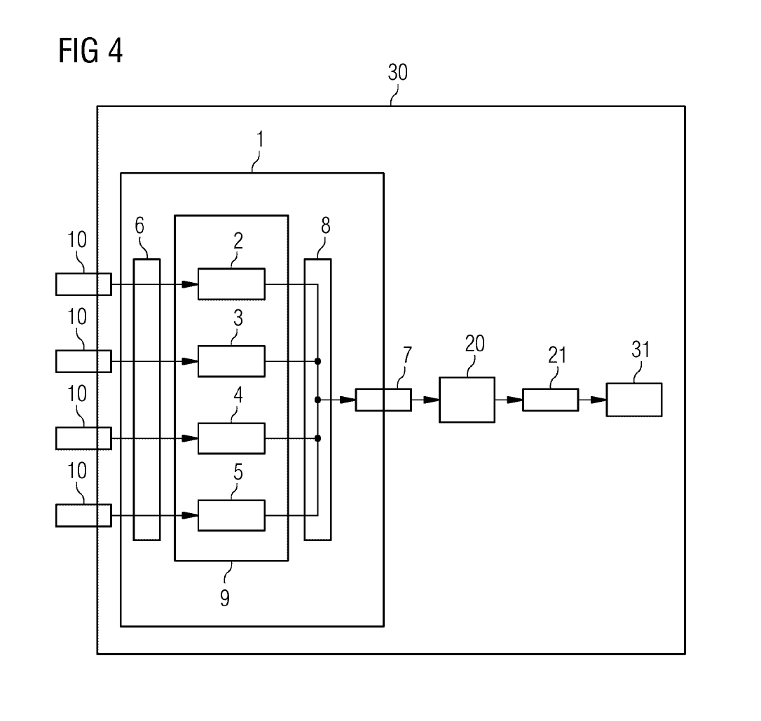

FIG. 4 illustrates another embodiment of an electrical switching device 30 which is designed in accordance with the design principle according to an embodiment of the invention. With this electrical switching device 30, the tripping element 20 is part of the electrical switching device 30, whereas the release unit 1 is designed as shown in FIG. 1.

When considered generally, the tripping element can optionally be part of the release unit or of the electrical switching device, such as a circuit breaker. Irrespective of where the tripping element is arranged, the conversion of different input signals into a common electrical output signal ensures that the tripping element can have a simple, in particular standardized, design. As a result, a large number of interfaces, in particular charging interfaces and tripping interfaces, are saved in comparison with electrical switching devices in which different releases are each per se connected to the electrical switching device. Such electrical switching devices have a simple, space-saving and inexpensive design owing to the release unit according to an embodiment of the invention.

### LIST OF REFERENCE SYMBOLS

1 Release unit
2 First release
3 Second release
4 Third release
5 Fourth release
6 Input signal
7 Common interface
8 Uniform electrical output signal
9 Electronics
10 Signal current
20 Tripping element
21 Mechanical signal
30 Electrical switching device/circuit breaker
31 Tripping mechanism

1. A release unit for tripping an electrical switching device, comprising:
two or more releases;
at least one interface configured to receive electrical input signals for each of the two or more releases; and
a common interface for a tripping element, configured to mechanically trip the electrical switching device, wherein the common interface is further configured to transmit a uniform electrical output signal to the tripping element, wherein each of the two or more releases includes electronics for converting the respective electrical input signal into the uniform electrical output signal.

2. The release unit of claim 1, wherein each of the two or more releases is designed for converting an electrical input signal formed as an electrical voltage into a uniform electrical output signal formed as a signal current.

3. The release unit of claim 1, wherein the common interface is in the form of a plug-type connection.

4. The release unit of claim 1, wherein
a first of the two or more releases is designed to convert at least one of a short-circuit current signal and an overload voltage signal into the uniform output signal,
a second of the two or more releases is designed to convert a residual current signal into the uniform output signal, and
at least one of
a third of the two or more releases is designed to convert an undervoltage signal into the uniform output signal and
a fourth release is designed to convert a working current signal into the uniform output signal.

5. The release unit of claim 1, wherein the tripping element for converting the generated output signal into a mechanical signal is part of the release unit, wherein the tripping element includes
a first interface, configured to connect to the common interface,
a tripping interface to a tripping mechanism of the electrical switching device, configured to transmit the mechanical signal to the tripping mechanism, wherein the mechanical signal is suitable for tripping the tripping mechanism, and
a charging interface, configured to transmit energy to the tripping element.

6. The release unit of claim 5, wherein the tripping element includes an electromagnet for converting the electrical output signal into the mechanical signal.

7. The release unit of claim 6, wherein the tripping element includes an energy store, connected downstream of the electromagnet, designed to amplify the mechanical signal generated by the electromagnet.

8. The release unit of claim 7, wherein the charging interface is designed for transmitting energy to the energy store.

9. An electrical switching device, comprising:
the release unit of claim 5; and
a tripping mechanism for tripping the electrical switching device, wherein the tripping mechanism includes a connection interface to the tripping interface of the tripping element for transmitting the mechanical signal from the tripping element to the tripping mechanism of the electrical switching device, and wherein the tripping mechanism is designed to disconnect the electrical switching device on reception of the mechanical signal.

10. An electrical switching device, comprising:
the release unit claim 1;
a tripping element for converting the output signal generated by the release unit into a mechanical signal, wherein the tripping element includes
a first interface, configured to connect the common interface of the release unit,
a tripping interface to a tripping mechanism of the electrical switching device for transmitting the mechanical signal to the tripping mechanism, wherein the mechanical signal is suitable for tripping the tripping mechanism, and
a charging interface for transmitting energy to the tripping element, and including a tripping mechanism for tripping the electrical switching device, wherein the tripping mechanism includes a connection interface to the tripping interface of the tripping element for transmitting the mechanical signal from the tripping element to the tripping mechanism of the electrical switching device, and wherein the tripping mechanism is designed to disconnect the electrical switching device on reception of the mechanical signal.

11. The electrical switching device of claim 10, wherein the tripping element includes an electromagnet for converting the electrical output signal into the mechanical signal.

12. The electrical switching device of claim 11, wherein the tripping element includes an energy store, connected downstream of the electromagnet, designed to amplify the mechanical signal generated by the electromagnet.

13. The electrical switching device of claim 12, wherein the charging interface is designed to transmit energy to the energy store.

14. The electrical switching device of claim 9, wherein the tripping mechanism of the electrical switching device includes at least one of a tripping shaft and a tripping latch.

15. The electrical switching device of claim 9, wherein the electrical switching device is a circuit breaker.

16. An electrical switching device, comprising:
the release unit of claim 6; and
a tripping mechanism for tripping the electrical switching device, wherein the tripping mechanism includes a connection interface to the tripping interface of the tripping element for transmitting the mechanical signal from the tripping element to the tripping mechanism of the electrical switching device, and wherein the tripping mechanism is designed to disconnect the electrical switching device on reception of the mechanical signal.

17. An electrical switching device, comprising:
the release unit of claim 7; and
a tripping mechanism for tripping the electrical switching device, wherein the tripping mechanism includes a connection interface to the tripping interface of the tripping element for transmitting the mechanical signal from the tripping element to the tripping mechanism of the electrical switching device, and wherein the tripping mechanism is designed to disconnect the electrical switching device on reception of the mechanical signal.

18. An electrical switching device, comprising:
the release unit of claim 8; and
a tripping mechanism for tripping the electrical switching device, wherein the tripping mechanism includes a connection interface to the tripping interface of the tripping element for transmitting the mechanical signal from the tripping element to the tripping mechanism of the electrical switching device, and wherein the tripping mechanism is designed to disconnect the electrical switching device on reception of the mechanical signal.

18. The electrical switching device of claim 15, wherein the electrical switching device is a compact circuit breaker.
